(19) United States
(12) Patent Application Publication
(10) Pub. No.: US 2015/0193464 A1
(43) Pub. Date: Jul. 9, 2015

(54) MICRO-JOURNALING FOR FILE SYSTEM BASED ON NON-VOLATILE MEMORY

(71) Applicants: Oh-seong Kwon, Hwaseong-si (KR); Hwan-soo Han, Seoul (KR); Sun-young Lim, Hwaseong-si (KR); Sung-tae Ryu, Suwon-si (KR)

(72) Inventors: Oh-seong Kwon, Hwaseong-si (KR); Hwan-soo Han, Seoul (KR); Sun-young Lim, Hwaseong-si (KR); Sung-tae Ryu, Suwon-si (KR)

(21) Appl. No.: 14/466,928

(22) Filed: Aug. 22, 2014

(30) Foreign Application Priority Data
Jan. 7, 2014 (KR) 10-2014-0002082

(51) Int. Cl. G06F 17/30; G06F 12/10; G06F 12/08

(52) U.S. Cl. CPC G06F 17/30191; G06F 12/0891; G06F 12/1009; G06F 2212/69; G06F 2212/652

(57) ABSTRACT

Provided is a micro-journaling for a file system based on a non-volatile memory. A system includes a central processing unit (CPU), a main memory realized in a non-volatile memory, and a storage device. The file system resides in the non-volatile main memory, and micro-journaling is performed. The micro-journaling includes a commit operation for flushing data of a CPU cache to a user space, and a checkpoint operation performed per page unit while a file write operation is performed through a system call. Since the non-volatile main memory is capable of permanently storing data, a data double duplication process for reliability of the file system may be removed, and the file system is recovered from a sudden power-off of the system by using the micro-journaling for recording logging information while the file write operation is performed and checking a point.

### CROSS-REFERENCE TO RELATED APPLICATIONS

This application claims the benefit of Korean Patent Application No. 10-2014-0002082, filed on Jan. 7, 2014, in the Korean Intellectual Property Office, the disclosure of which is incorporated herein in its entirety by reference.

### BACKGROUND

The present disclosure relates to a memory system, and more particularly, to a micro-journaling for a file system using a non-volatile memory.

In the near future, non-volatile memories are highly expected to replace current main memories in mainstream computer systems. From a register file in a processor, through a cache, a main memory and a secondary storage is organized to provide fast and large memory systems, and this memory system hierarchy has been well-established for years. Recently developed non-volatile memories have been lagging in performance when comparing read/write access times and durability to those of dynamic random access memory (DRAM). However, newly found non-volatile memories are showing similar performances compared to DRAM, in access times and endurance. The non-volatile memories can permanently store data even after power-off. When the non-volatile memories are employed as main memories in memory hierarchy designs, file systems should be changed to embrace the non-volatile memories. In detail, reliability of a file system based on a non-volatile memory need to be better secured.

### SUMMARY

The present disclosure provides a system using micro-journaling in a file system based on a non-volatile memory, and a method of recovering the system.

According to an aspect of the inventive concept, a system includes: a central processing unit (CPU) for controlling operations of the system, including a CPU cache; and a main memory for performing micro-journaling, wherein the micro-journaling includes a commit operation for flushing data of the CPU cache to a user space of the main memory, and the main memory is a non-volatile memory where a file system resides.

The main memory may be any one of a spin transfer torque magnetic random access memory (STT-MRAM), a resistance random access memory (ReRAM), and an MRAM, and a ferroelectric random access memory (FeRAM).

The system may further include a storage device for storing data processed in the system.

The storage device may be used for swapping file data extracted from a virtual memory in the main memory.

The micro-journaling may use the user space of the main memory as a data log space.

The micro-journaling may include a checkpoint operation for marking an update of a file write by a system call during recovery rewrites of the micro-journaling.

The checkpoint operation may use an input/output (I/O) vector, the I/O vector having a pointer to a base virtual address of source data and a length of data for an unfinished file write caused by the sudden power-off of the system.

The checkpoint operation may use a page directory, the page directory accessing a top level of a page table for the file write.

The micro-journaling may perform an atomic and ordered file write on the file system through the commit operation.

The micro-journaling may transactionally update a source data according to a system call as a whole.

The micro-journaling may be used for rebooting after a sudden power-off of the system to recover the file system.

According to another aspect of the inventive concept, a method of recovering a system includes: rebooting the system after a sudden power-off; restoring a page table to a user space of a nonvolatile main memory; and rerunning a file write that was stopped during the sudden power-off, by micro-journaling in the main memory.

According to another aspect of the inventive concept, a system includes: a central processing unit (CPU); and a non-volatile main memory for copying a code executed by the CPU, driving a file system, and performing a micro-journaling, wherein the micro-journaling includes: a commit operation for flushing data of the CPU cache to a user space of the main memory, a checkpoint operation for marking an update of the file write per page unit by a system call, and a recording operation of a data log of the user space.

### BRIEF DESCRIPTION OF THE DRAWINGS

Exemplary embodiments of the present inventive concepts will be more clearly understood from the following detailed description taken in conjunction with the accompanying drawings in which:

FIG. 1 is a block diagram of a system according to an exemplary embodiment of the present inventive concepts;

FIGS. 2 and 3 are diagrams for respectively describing traditional journaling and shadow-paging;

FIG. 4 is a diagram of a file system based on a non-volatile memory, according to an exemplary embodiment of the present inventive concepts;

FIG. 5 is a diagram for describing micro-journaling including commit and checkpoint timings, according to an exemplary embodiment of the present inventive concepts;

FIG. 6 is a diagram for describing micro-journaling of a file system based on a non-volatile memory, according to an exemplary embodiment of the present inventive concepts;

FIG. 7 is a diagram for describing a checkpoint operation in micro-journaling, according to an exemplary embodiment of the present inventive concepts;

FIG. 8 is a diagram for describing a boot mechanism and recovery mechanism in a system using micro-journaling, according to an exemplary embodiment of the present inventive concepts;

FIG. 9 is a diagram for describing a recovery process in a file system using micro-journaling, according to an exemplary embodiment of the present inventive concepts;

FIG. 10 is a diagram of a magnetic random access memory (MRAM) according to an exemplary embodiment of the present inventive concepts;

FIG. 11 is a diagram of a memory cell array in a memory bank of FIG. 10, according to an exemplary embodiment of the present inventive concepts;

FIG. 12 is a stereogram of a spin transfer torque (STT)-MRAM cell of FIG. 11, according to an exemplary embodiment of the present inventive concepts;

FIGS. 13A and 13B are diagrams for describing a magnetization direction according to data written on a magnetic tunnel junction (MTJ) device of FIG. 12, according to an exemplary embodiment of the present inventive concepts;

FIG. 14 is a diagram for describing a write operation of the STT-MRAM cell of FIG. 12, according to an exemplary embodiment of the present inventive concepts;

FIGS. 15A and 15B are diagrams for describing MTJ devices in the STT-MRAM cell of FIG. 12, according to exemplary embodiments of the inventive concepts;

FIG. 16 is a diagram for describing an MTJ device in the STT-MRAM cell of FIG. 12, according to another exemplary embodiment of the present inventive concepts; and

FIGS. 17A and 17B are diagrams for describing dual MTJ devices in the STT-MRAM cell of FIG. 12, according to other exemplary embodiments of the present inventive concepts.

### DETAILED DESCRIPTION

Hereinafter, the present disclosure will be described more fully with reference to the accompanying drawings, in which exemplary embodiments of the present inventive concepts are shown. Like reference numerals in the drawings denote like elements.

This inventive concept may, however, be embodied in many different forms and should not be construed as limited to the exemplary embodiments set forth herein.

The terms used in the present specification are merely used to describe particular embodiments, and are not intended to limit the inventive concept. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. Unless indicated otherwise, these terms are only used to distinguish one element from another. For example, a first chip could be termed a second chip, and, similarly, a second chip could be termed a first chip without departing from the teachings of the disclosure.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items. Expressions such as “at least one of,” when preceding a list of elements, modify the entire list of elements and do not modify the individual elements of the list.

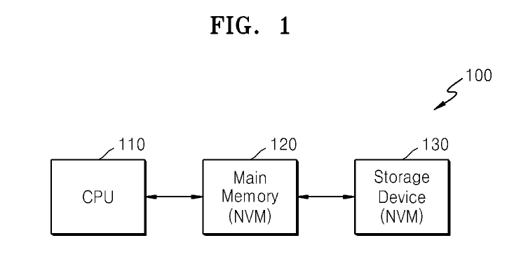

FIG. 1 is a block diagram of a system 100 according to an exemplary embodiment of the present inventive concepts.

Referring to FIG. 1, the system 100 includes a central processing unit (CPU) 110, a main memory 120, and a storage device 130. The system 100 may be included in a terminal, such as a computer. Here, the system 100 may be, for example, a mobile system, such as a mobile phone, a smart phone, a personal digital assistant (PDA), a portable multimedia player (PMP), a digital camera, a music player, a portable game console, or a navigation system.

The CPU 110 controls an overall operation of the system 100. The CPU 110 may perform a command corresponding to a code by executing the code copied in the main memory 120. The CPU 110 may perform various computing functions, such as certain calculations or tasks. According to one or more embodiments, the CPU 110 may include one processor core (single core) or a plurality of processor cores (multi-core). For example, the CPU 110 may include a dual-core, a quad-core, or a hexa-core. According to one or more embodiments, the CPU 110 may further include an internal or external cache memory.

Not only a code executed by the CPU 110 may be copied in the main memory 120, but also data processed according to a command may be stored in the main memory 120. The main memory 120 may drive a plurality of pieces of software or firmware. For example, the main memory 120 may drive an operating system (OS), an application, a file system, a memory manager, and an input/output (I/O) driver.

The OS may control software or hardware resources of the system 100, and may control program execution by the CPU 110. The application denotes any one of various application programs executed in the system 100. The file system may systematize a file or data when the file or data is stored in a storage region, such as the main memory 120 or the storage device 130. The file system may provide address information according to a write or read command to the storage device 130. The file system may be used according to a certain OS executed in the system 100. The memory manager may control a memory access operation performed by the main memory 120 or the storage device 130. The I/O driver may transmit information between the system 100 and various peripheral devices or a network, such as Internet.

The storage device 130 may be a data storage device based on a flash memory. The storage device 130 may include, for example, a flash memory, a controller, and a buffer memory. The storage device 130 may be, for example, a memory card device, a solid state device (SSD), an advanced technology attachment (ATA) bus device, a serial advanced technology attachment (SATA) bus device, a multimedia card device, a secure digital (SD) device, a memory stick device, a hybrid drive device, or a universal serial bus (USB) flash device.

The flash memory may be connected to the controller through an address or data bus. The flash memory may be divided into a data region and a meta region. General user data or main data may be stored in the data region, and metadata (for example, mapping information according to a flash transition layer (FTL)) required to drive the flash memory or the storage device 130, aside from the user data, may be stored in the meta region.

The controller may transmit and receive data to and from the flash memory or buffer memory through the address or data bus. The controller may include a mapping manager including an FTL and a page map table, and a local memory used to drive the mapping manager. The FTL enables the flash memory to be efficiently used. The FTL converts a logical address provided by the CPU 110 to a physical address usable by the flash memory.

The FTL manages such an address conversion through a map table. The map table shows logical addresses and physical addresses corresponding to the logical addresses. The map table may have a different size according to a mapping unit, and may use any one of various mapping methods. A page map table may be a map table in a page unit and may be used to convert a logical address number (LAN) to a physical page number (PPN).

The main memory 120 may be realized by using a non-volatile memory. A magnetic random access memory (MRAM) that is one of the non-volatile memories is a magnetoresistance-based non-volatile memory. The MRAM is different from a volatile RAM in several ways. Since the MRAM is non-volatile, the MRAM may maintain data stored therein even when a memory device is turned off.

Generally, a non-volatile RAM is slower than the volatile RAM, but the MRAM has read and write response times comparative to those of the volatile RAM. Unlike typical RAM technologies storing data as electric charges, the MRAM stores data according to magnetoresistance components. Generally, magnetoresistance components include two magnetic layers, wherein each magnetic layer has magnetization.

The MRAM is a non-volatile memory for reading and writing data by using a magnetic tunnel junction (MTJ) pattern including two magnetic layers and an insulating film between the magnetic layers. A resistance value of the MTJ pattern may vary according to a magnetization direction of the magnetic layer, and data may be programmed or erased by using a difference between resistance values.

In the MRAM using a spin transfer torque (STT) phenomenon, the magnetization direction of the magnetic layer switches according to spin transfer of electrons when a spin polarized current is supplied in one direction. The magnetization direction of one magnetic layer (pinned layer) is fixed and the magnetization direction of the other magnetic layer (free layer) may be switched according to a magnetic field generated by a program current.

The magnetic field of the program current may arrange the magnetization directions of the two magnetic layers to be parallel or anti-parallel. When the magnetization directions are parallel, resistance between the two magnetic layers is in a low (0) state. When the magnetization directions are anti-parallel, the resistance between the two magnetic layers is in a high (1) state. The switching of the magnetization direction of the free layer and the high or low state of the resistance between the magnetic layers enable the MRAM to perform write and read operations.

Although the MRAM is non-volatile and provides a quick response time, an MRAM cell has a scaling limitation and is sensitive to write disturbance. The program current applied to switch the state of the resistance between the magnetic layers is generally high. Thus, when a plurality of cells are arranged in one MRAM array, the program current applied to one cell induces a field of the free layer of an adjacent cell to change. Such write disturbance may be reduced by using an STT phenomenon.

A typical STT-MRAM includes an MTJ device. The MTJ device is a magnetoresistance data storage device including two magnetic layers (a pinned layer and a free layer) and an insulating layer between the magnetic layers.

A program current generally flows through the MTJ device. The pinned layer polarizes an electron spin of the program current, and the spin-polarized electron current passes through the MTJ device to generate a torque. The spin-polarized electron current applies the torque on the free layer to mutually operate with the free layer.

When the torque passing through the MTJ device is higher than a threshold switching current density, the torque is enough to switch a magnetization direction of the free layer. Accordingly, the magnetization direction of the free layer may be parallel or anti-parallel to the pinned layer, and resistance between the magnetic layers is changed.

The STT-MRAM does not require an external magnetic field required for the spin-polarized electron current to switch the free layer. Moreover, scaling is improved according to a program current reduction along with a cell size reduction, and write disturbance is prevented. In addition, the STT-MRAM may have a high tunnel magnetic resistance ratio and allows a high ratio between high and low states, and thus improves a reading operation in a magnetic domain.

The MRAM is a universal memory device having low expenses and high capacity characteristics of a dynamic random access memory (DRAM), a high speed operation characteristic of a static random access memory (SRAM), and a non-volatile characteristic of a flash memory.

The main memory 120 may be realized by using the STT-MRAM. According to one or more embodiments, the main memory 120 may be realized as a resistance random access memory (ReRAM), an MRAM, a ferroelectric random access memory (ReRAM), or a similar memory thereof.

The main memory 120 is a non-volatile memory, but may have a page cache like a conventional volatile memory used in a virtual memory system. Like a cache of the CPU 110, the page cache is used for copying a portion of data from the storage device 130 into the main memory 120, updating the copied data and write back the updated data to the storage device 130 by page unit. The page unit in the virtual memory system is a unit for paging that is different from the physical page for write/read unit of the flash memory described in FIG. 1.

Since the main memory 120 is realized as a non-volatile memory, micro journaling supporting transactional write system calls in a file system based on a non-volatile memory is suggested to support reliability of the file system. The micro journaling allows data update of all processor caches to be recorded in non-volatile memories before power-off when a write system call is invoked. The micro journaling generates micro journals in a kernel space in the non-volatile main memory during the write system call. In order to improve the micro-journaling, data may be flushed within a specified address range. The micro journaling may be resumed even when a system is suddenly turned off during the write system calls.

Before describing the micro-journaling, traditional journaling and shadow-paging for ensuring reliability of a file system will be described. The traditional journaling and shadow-paging ensures the reliability of the file system when a main memory is a DRAM.

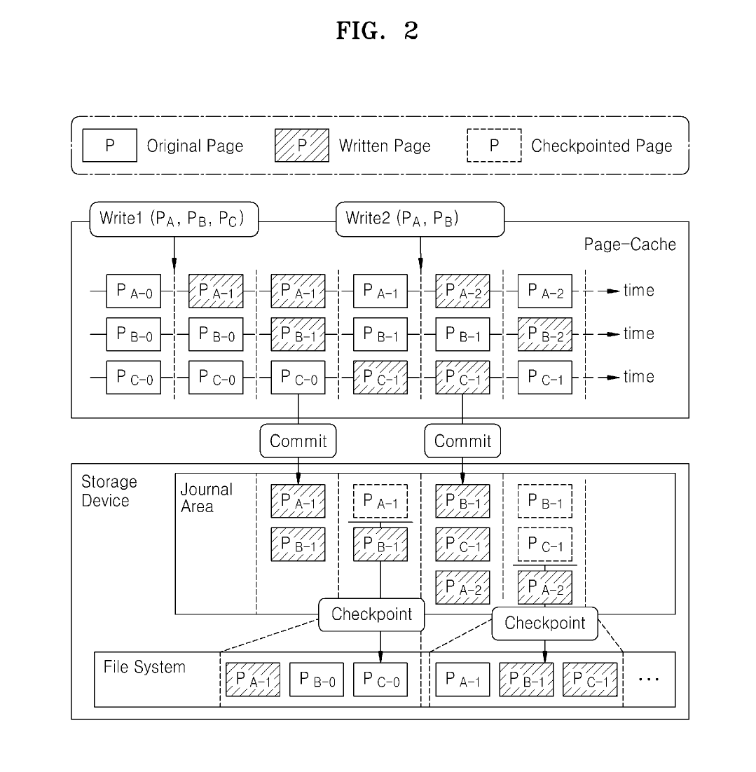

FIGS. 2 and 3 are diagrams for respectively describing traditional journaling and shadow-paging.

Referring to FIG. 2, when an application program is executed, write system calls are invoked with data to update. For example, two system calls, i.e., write1 and write2 may be invoked. During write system calls, corresponding page caches in the main memory are updated. Here, three pages PA, PB, and PC are written from write1 and two pages PA and PB are written again from write2. Numbers following page indicators represent a version of pages after multiple updates. For example, the page PA is originally PA-0, becomes PA-1 from write1, and finally becomes PA-2 from write2. If a number of page caches to update is large enough in a storage device, a group of page caches is written on a journal area in a first storage space. A process of recording content of page cache in a storage device is called a general commit operation.

Since the system may fail or crash during a write operation performed on the storage devices, journaling separately keeps records of updates in the journal area. For example, commit operations occur when two pages are ready to be written thereon. In a first commit operation, pages PA-1 and PB-1 are committed to the storage device. Then, pages PC-1 and PA-2 are committed in a second commit operation. A page PB-2 is not committed yet.

The file system is independently updated to reflect written pages one by one from the journal area. While updating the file system, a checkpoint is marked to indicate which pages in the journal area are successfully updated to the file system.

Even if the system fails before completely updating a page, the system may rewrite the page from the journal area to the file system. In terms of the file system, the journal area already has duplicate pages. Thus, any updates committed to the journal area may be reliably reflected to the file system. For a page cache, only pages that are successfully written to the journal area are regarded as pages written to the file system. Thus, the journaling has an inherent overhead that performs write operations on the storage twice, i.e., one on the journal area and the other on the file system.

FIG. 3 shows the shadow-paging originally developed from database systems. In the shadow-paging, atomic and durable transactions are key operations for integrity of the database system. The shadow-paging may be used in the file system. The implementation of shadow-paging adopts a copy-on-write mechanism. When a file write transaction starts, a duplication of original data, called a shadow page, is prepared. In-memory file systems use a page as a unit for storing file data. For reliability, a page is also used as a basic unit to secure atomicity and consistency of file writes. When file data is being written on in-memory file systems, a duplication of an original page is required.

A file operation write1 updates three pages PA, PB, and PC. Before a page is written on an original page PA-0, a duplication of the original page PA-0 is prepared as a shadow page P′A-0. Then, content of the shadow page P′A-0 is updated to a page PA-1. An inode structure in a kernel contains metadata of a file. An inode is also referred to as an index node. Mapping information, i.e., one of metadata, is represented with an address space structure of a file. When the shadow page P′A-0 is successfully written, mapping information in metadata (address space) is atomically changed to designate the updated shadow page P′A-0. A pointer of a page PA-0 is changed to a page PA-1. Then, the original page PA-0 is released. In addition, metadata on a file size and allocated page numbers are also updated. For remaining pages, the same shadow-paging mechanism is performed to update the in-memory file system.

Since updates to shadow pages and metadata may be still in a CPU cache, cache lines containing such data may be properly flushed to a main memory for file system integrity. An order of flushes between data and metadata must be preserved. After cache lines for data pages are all flushed to the main memory, cache lines for metadata are flushed. Shadow-paging has an inherent overhead of page duplication for shadow pages, which, in principle, imposes the same overhead as journaling.

Since file systems in normal operating systems are implemented with consideration of latency between a volatile main memory and a storage device, systems with nonvolatile main memory may need a new file system design.

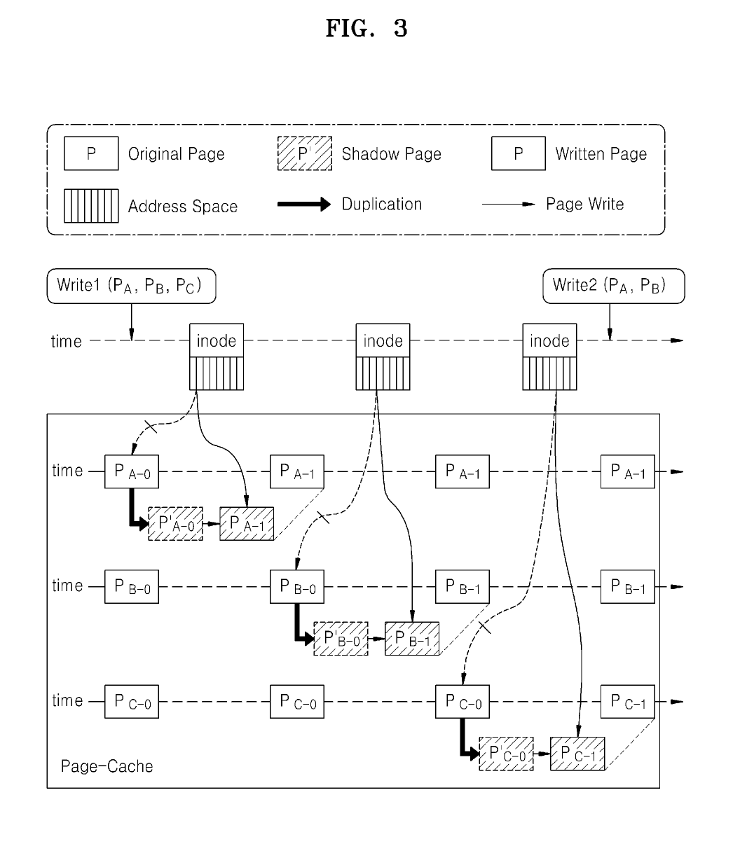

FIG. 4 is a diagram of a file system based on a non-volatile main memory, according to an embodiment of the present inventive concepts.

Referring to FIG. 4, the file system persistently stores data in the non-volatile main memory 120 realized in a non-volatile memory. As such, the file system resides in the non-volatile main memory 120. The storage device 130 may work as backing storage device for swapping file pages from the virtual memory embodied in the non-volatile main memory 120.

In the file system, a latency time of file accesses may be reduced. Since files are initially maintained in the non-volatile main memory 120, file data may be transmitted more rapidly from the first access. Conventional file systems have block-level device layers to interact with a storage device to achieve reliability of the file systems. In the file system according to the exemplary embodiment of the present inventive concepts, a page cache in the non-volatile main memory 120 instead of a block level device layer between a volatile storage device and a non-volatile storage device may achieve reliability and transactional write of the file system. When infrequently used file data is selected for eviction pages from a virtual memory system, the storage device 130 may store the evicted pages by swapping operation in a swap space in the storage device 130.

An operation method of the file system for achieving reliability and transactional write may be much lighter than that of a file system using a general volatile main memory. Conventional file systems use a heavy reliability technique with journaling, which writes journal logs on a storage device. On the other hand, the file system according to an exemplary embodiment of the present inventive concepts may not require a reliability mechanism to preserve consistency between the non-volatile main memory 120 and the storage device 130. Despite of the non-volatility in the main memory 120, a reliability mechanism between the CPU 110 and the non-volatile main memory 120 is still desirable.

To help ensure the reliability between the CPU 110 and the non-volatile main memory 120, each file operation should be atomic and ordered. The micro journaling according to an exemplary embodiment of the present inventive concepts includes flushing cache lines in a specific order to help ensure a transactional write, and recording a micro-journal.

The transactional write may achieve a recording operation that satisfies all four elements, i.e., atomicity that achieve a completely finished or completely unfinished state of a recording process, consistency about whether content and meta information of data to be stored match those of data actually applied to a file, isolation that ensures non-interference of another recording operation during recording, and durability that ensures whether data to be stored once is permanently recorded.

Persistency of the file system may be supported by modifying booting operations of operating systems. As the file system is built upon page caches, a kernel structure such as page tables and inodes is maintained during power-offs and reboots, without being lost. According to an embodiment of the present inventive concepts, when the system restarts the operating system, user data and information about a file system, which are pre-stored in the nonvolatile main memory may be used such that the file system may have a better performance after reboots. Here the information about a file system may include a super block that stores states of the file system as a whole. The super block may include, for example, a type, name and total size, management block size, mount location, used size, unused size, and connection information of a root directory of the file system.

When the system is suddenly turned off, a reboot sequence needs to restore the page tables and access the inodes and journal logs on a virtual address space. Thus, all contents in the page tables may be the latest, and page tables updated in dirty cache lines of a CPU cache may be all stored in a nonvolatile memory before the system is turned off. Here, a dirty cache line means a cache line including data that is only updated in a CPU cache and not yet written in a storage device. Also, in order to prevent the system from being turned off before the dirty cache lines of the CPU cache are all updated in the nonvolatile memory, page tables may be arranged in uncacheable areas.

For a write system call, data in a user space is transferred to the write system call as a source for a write operation. The data resides in the user address space and has a very valuable role in micro journaling for a non-volatile memory system. Since the data is retained in the non-volatile memory even after power-off and reboot, a source data for a write system call may be permanent once any dirty cache lines of the data are properly flushed to the non-volatile main memory 120. Thus, the data in a user space may be used as a journaling log, so there is no need to duplicate the data in the main memory in the storage device against a sudden power-off like a conventional file system. The micro journal in a kernel space may have all the information to track the data in the user space so that the micro journaling is much lighter way to secure reliability and transactional write of a file system compared to the conventional journaling.

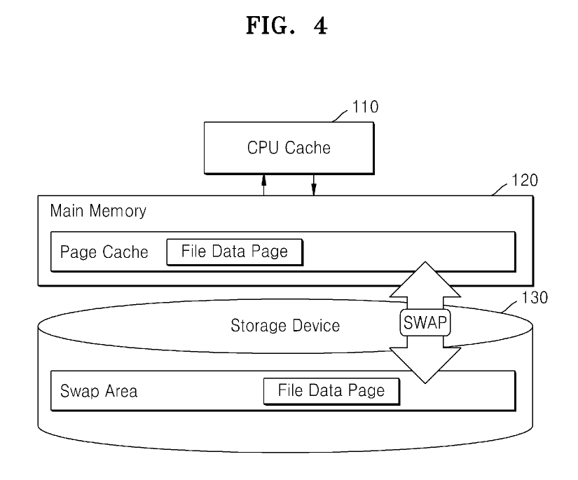

FIG. 5 is a diagram for describing micro journaling including commit and checkpoint timings, according to an embodiment of the present inventive concepts.

FIG. 5 shows how micro journaling uses a CPU cache, a user space, a kernel space and a storage space for commit and checkpoint operations according to a write system call. In the micro-journaling, a file system resides in the non-volatile main memory 120. During the commit operation, the micro journaling requests data stored in the cache of the CPU 110 flushed to a user space 122 of the non-volatile main memory 120.

Once committed data are regarded as data recorded in a file system 124, checkpoint operations are performed to assure that all the committed data are properly written on the file system 124. If committed data does not complete the total write operation by the write system call during checkpoint operation due to sudden power-off of the system, the committed data may be rewritten at the next reboot time. This is the reason why journaling logs are kept at the non-volatile area and necessary records for rewriting data on the file system are kept. Thus, at the beginning of a write system call, the micro journaling flushes CPU cache lines related to the source data in the user space 122 and generates a micro journal in the kernel space 124 according to the stored source data in the non-volatile memory 120 and updates kernel space 124 by moving the source data from the user space 122 to the kernel space 124 during a checkpoint operation. After updating the kernel space during checkpoint operation, the micro journal related to the write system call in the kernel space 124 may be deleted or invalided.

The user space 122 may be an area to store updated data by processes invoked by the file system. The kernel space 124 may be an area for managing the file system by the operating system (OS) and may include an inode, a page table, various kinds of data structure, scheduler, process information, and a data structure for memory system management. The kernel space 124 may have a cache area for paging of a virtual memory system. The inode may include a micro-journal.

The storage device 130 may include a swap space to swap pages between the non-volatile main memory 120 and the storage device 130.

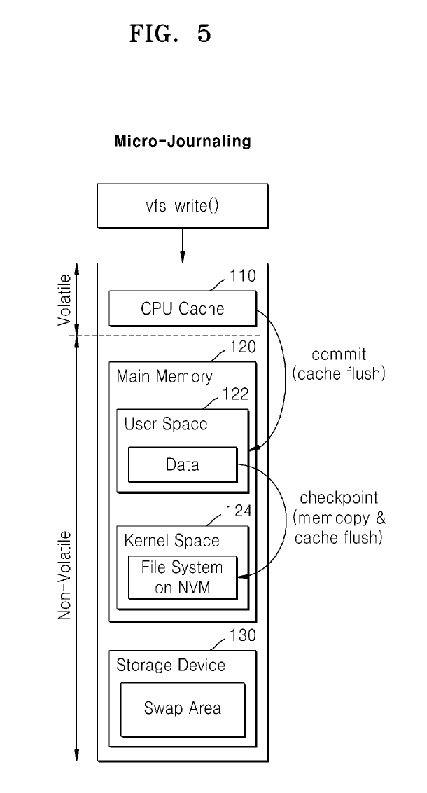

FIG. 6 is a diagram for describing the micro journaling of the file system, according to an embodiment of the present inventive concepts.

Referring to FIG. 6, to recover the file system from a sudden power-off of the system, the inode may store a pointer for accessing a micro journal therein, in the micro-journaling. The micro journal 610 contains a I/O vector 612 and a page directory 614 for a recovery operation. The I/O vector 612 includes information about a base virtual address 617 of source data 630 and a length 618 of data for a write system call. The base virtual address 617 represents where a page storing source data 130 stored in a user space is located in a virtual address space. By using the base virtual address, recovery may be performed for a committed file write by resuming any remaining updates to the file system after the sudden power-off of the system. To resume the remaining updates to the file system, a virtual address is converted to a physical address 630 by searching for a page directory 619 related to a process having the remaining updates by referring to the page directory 614, and then searching for a page table 620 by referring to a I/O vector 612 of a micro journal 610 indicating a physical location of source data. When the recovery is performed at reboot, a physical address of the source data may be generated according to a virtual address 617 of the I/O vector 612.

The page directory 614 of the micro journal 610 is designed to be input to the control register CR3 in the CPU 110, and to point an entry of the page directory 614. The micro-journaling searches the page directory 614 and the page table 620 to find a physical address of updated data. A pointer in the page table 620, which is stored in the entry of the page directory 614, outputs a physical address 630 of a page that is updated source data.

A page directory offset and a page table offset is provided by the base virtual address 617. The first portion of the base virtual address 617 corresponds to the page directory offset and the second portion of the base virtual address 617 corresponds to the page table offset. The base virtual address 617 may include a third portion as an offset of a physical page table (not shown) to find the physical location of the source data 300.

The page directory 619 and the page table 620 may be located in a kernel space and the page directory may be located in the top-level of the area for storing the page table 620.

The page directory 614, e.g., one field in the micro journal 610, is used to access the page table 620 while the micro journal 610 is generated. The micro journal 610 may also contain a predetermined field for checkpoint information 616. The checkpoint information 616 is used to track a page level progress of generic file write for the write system call. The checkpoint information 616 may indicate a completion of data write by page unit during the checkpoint operation.

When data in a user space is a part of a stored file, the data in the user space may be transferred to a write system call. The micro-journaling performs commit operations to move the data of the dirty cache lines to the non-volatile main memory. The commit operation according to an embodiment of the inventive concept includes flushing of a CPU cache and generating of a micro-journal. By using a cache line flush instruction, the flushing of the CPU cache may selectively move the data of the dirty cache lines to the non-volatile main memory. Upon the completion of the all necessary cache line flushes, committing of the file write may be completed. Although the file system is not updated yet after the commit operation, persistent data is already written in the nonvolatile main memory. Thus, the file write may be redone during a recovery process even if the system is suddenly turned off before the completion of the file write, thereby stably completing the file write.

When the file write starts according to the write system call, an address of source data is written on a micro-journal. To commit data from the CPU cache, the micro-journaling uses memory barriers and cache line flush instructions. Through the commit operation, the micro-journaling performs an atomic and ordered file write on the file system.

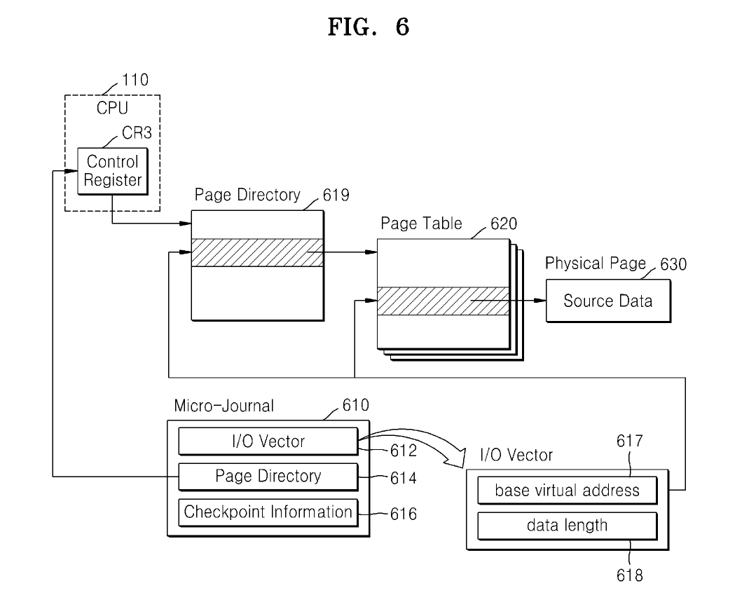

FIG. 7 is a diagram for describing the checkpoint operation in the micro-journaling, according to an embodiment of the inventive concept.

Referring to FIG. 7, the checkpoint operation 710 in the micro-journaling may be performed in page units for a file write. However, write units and checkpoint units may differ according to a structure of a nonvolatile main memory.

In the micro-journaling, the checkpoint operation 710 is performed after source data is written from a user space of a page cache to a kernel space. A target of a checkpoint may be user data and metadata related to the user data. The checkpoint represents a progress per page write for a write system call. During the checkpoint, information about the checkpoint is stored in a checkpoint information field 616 (FIG. 6) in the micro journal 610. By using the information about the checkpoint, the file system may be restored from a sudden power-off of the system through the recovery process, and may complete an uncompleted write system call.

A micro journal may be generated per process, and when several processes are simultaneously performed, several micro journals may simultaneously exist in a page cache.

In the micro-journaling, the source data for write system calls may be committed for successive virtual memory pages, not by a page unit. For example, all cache lines of a CPU related to all virtual addresses from a base virtual address to range of a data length may be committed by using a I/O vector of a micro-journal. In one exemplary embodiment, if the cache lines of the CPU are already committed and there are no more dirty cache lines in a CPU cache, additional recording is not performed on the nonvolatile main memory 120.

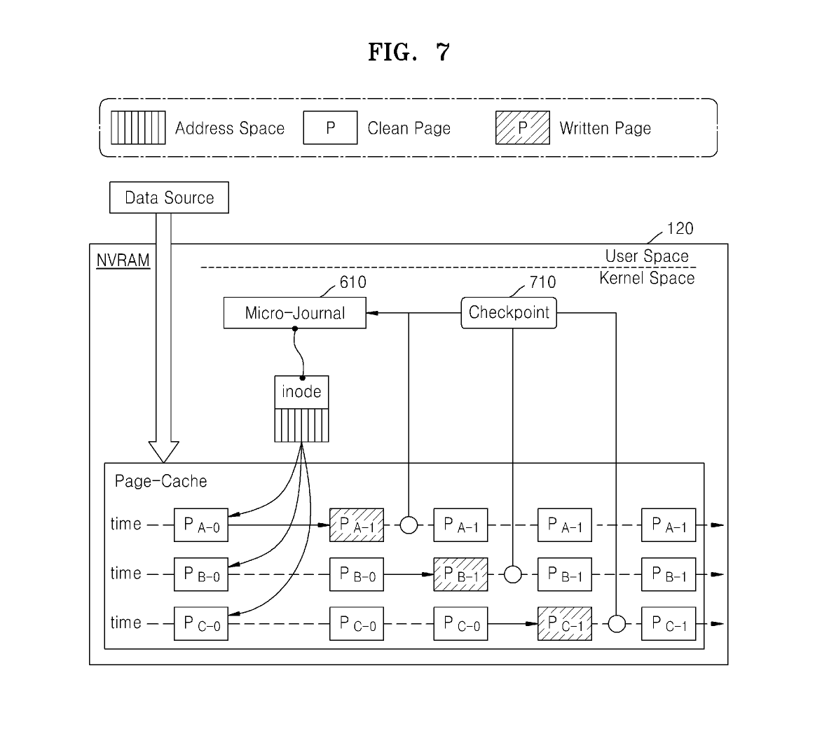

FIG. 8 is a diagram for describing a boot mechanism and a recovery mechanism in a system 800 using the micro-journaling, according to an embodiment of the inventive concept.

Referring to FIG. 8, the system 800 may include a system boot-up module 810, a system operating module 820, and a system shutdown module 830.

The system boot-up module 810 operates a booting operation after power is supplied to the system 800. The system boot-up module 810 may include a fresh boot module 812, a normal boot module 814, and a recovery boot module 816. Since the fresh boot module 812 initializes all kernel structures and page caches of the system 800, the fresh boot module 812 may initialize the system 800 to a factory state and generate an initial snapshot to be stored in the main memory 120. The fresh boot module 812 may boot the system 800 by using the initial snapshot stored in the non-volatile main memory 120.

When it is determined that there is no system error during a booting process, the normal boot module 814 may boot the system 800 by using a snapshot generated when the system 800 is shut down and stored in the non-volatile main memory 120. The system boot-up module 810 may determine a system error by referring to a system error signal received from the system operating module 820.

When it is determined that there is a system error by referring to the system error signal, the recovery boot module 816 may request a system error state module 822 for booting including recovery. Also, the recovery boot module 816 may receive system error information according to a sudden power-off of the system 800 from the system error state module 822, and perform recovery boot 850.

The system operating module 820 may include the system error state module 822 and a system normal state module 824. The system error state module 822 may store the system error information generated in the system 800, and may transmit the system error information to the system boot-up module 810 during booting.

The system normal state module 824 may store system state information when the system 800 normally operates. Also, the system normal state module 824 may receive a reboot request from the system error state module 822 when the recovery boot 850 is performed and the system 800 is normally recovered. Accordingly, the system normal state module 824 may update the stored system state information and request the system shutdown module 830 to shutdown the system 800.

According to the exemplary embodiments of the present inventive concepts, a boot mechanism may include shutdown and wake-up of the system 800, and may be realized based on an advanced configuration and power interface (ACPI) protocol. For example, the system 800 may shut down the system 800 by using a suspend-to-RAM or suspend-to-disk having a snapshot in an ACPI protocol.

The system 800 according to an exemplary embodiment may shut down by performing the suspend-to-RAM instead of the suspend-to-disk in response to a normal system shutdown request. The system 800 may perform the suspend-to-RAM to store various types of information required for booting during the shutdown in the non-volatile main memory 120, and then turns off the system 800. The suspend-to-disk is an operation of transferring various types of information required for booting during the shutdown to a storage device before the system 800 is turned off. At reboot, a normal boot is possible after a power-down by performing a suspend-to-RAM operation instead of suspend-to-DISK operation because update information is still remained in the non-volatile main memory 120.

The main memory 120 may include a boot region 841, a snapshot 842 used during a suspend state of the system 800, a user space 843 according to processes, a file system page 844, a page table 845 for managing a virtual memory, and a micro journal 846 for a reliable file write.

Normal boot means booting of the system 800 when there is no system error, and may be completed by performing a wake-up-from-RAM in the ACPI protocol. Since latest update information of the system 800 according to an exemplary embodiment of the present inventive concepts is stored in the non-volatile main memory 120, the normal booting is possible even by performing wake-up referring to the non-volatile main memory 120. As such, the suspend-to-RAM may be considered as a normal power-off and a wake-up-from-RAM may be a normal boot after complete power-off.

The recovery boot 850 means booting of the system 800 while recovering the system 800 by resuming a file write operation when the system 800 suddenly stops. The recovery boot 850 operates by using various types of information stored in the non-volatile main memory 120, and initial booting after the sudden stop of the system 800 may be set to be the recovery boot 850.

The recovery boot 850 may perform a general initialization operation of an OS in operation 851, and enables a file write operation to be normally completed by resuming the file write operation in operation 852. In operation 852, the file write operation is completed in the file system page 844 by using data in the user space 843 by referring to the micro journal 846 and the page table 845 before being recovered to a snapshot. Then, a state of the file system is recovered by using the snapshot 842 in operation 853, and the recovered file system is stored in a register in operation 854, and then the system 800 is restarted by requesting a reboot operation 855.

A recovery mechanism may be included as a part of a boot step. The recovery mechanism is used to reboot the system 800 after the sudden power-off of the system 800, and file writes for the file system recovery may be redone at this time. To perform unfinished writes due to the sudden power-off, the I/O vector 612 in the micro journal 846 may be scanned and related inodes may be looked up to figure out unfinished page-unit write operation to the file system. For redoing writes, data to be copied from the user space 843 may be searched for by using a base virtual address stored in a I/O vector 612. Since the micro journal 846 contains a pointer of a page directory copied to the control register, the recovery process may search source data of file writes. The file system may be restored across system shutdowns and reboots. Related kernel structures including inodes and page caches may be designed to be placed in a specific memory zone so as not to be mixed with kernel structures to initialize for reboot. Thus, the recovery file writes may proceed after the file system is restored for use.

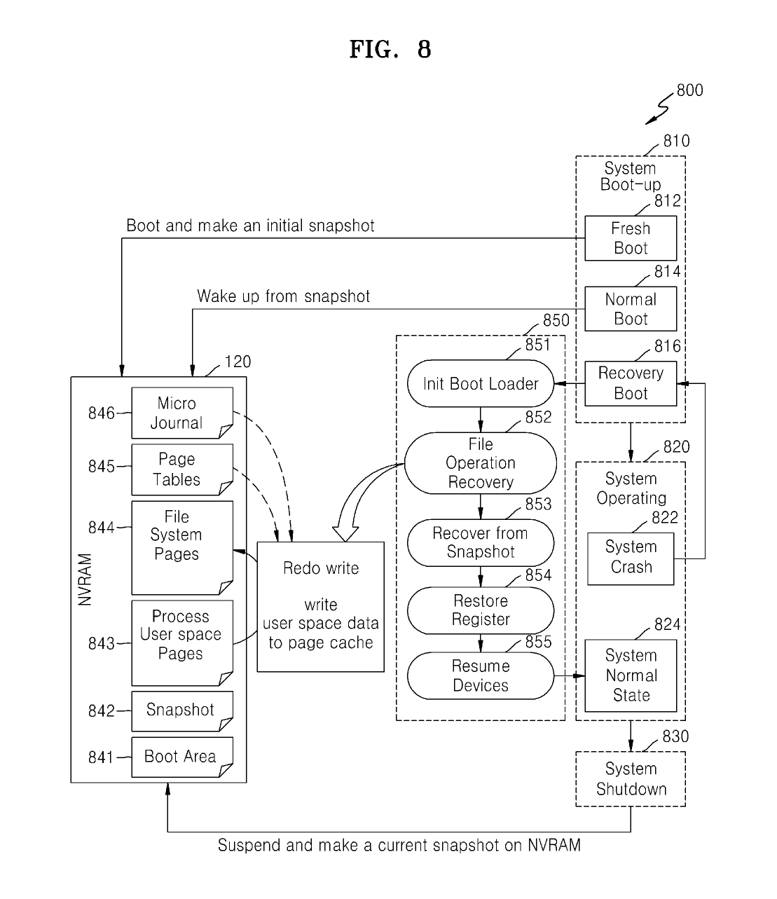

FIG. 9 is a diagram for describing the recovery process in the file system using the micro-journaling, according to an embodiment of the inventive concept.

Referring to FIG. 9, the file write operation may be stopped as the power is blocked due to the sudden power-off of the system. In this case, the system is rebooted according to the recovery boot and thus enters a system recovery process. The page table may be restored in operation S1 by using the data committed to the user space of the main memory 120 realized as a non-volatile memory. The micro journal is searched by using the restored page table, in operation S2. Then, the file write operation that was stopped due to the sudden power-off may be requested to be redone by referring to the micro journal in the main memory 120 in operation S3. In operation S4, the file write operation is redone to update source data of the user space into the kernel space in the file system.

The micro-journaling may include the commit operation for flushing data in the CPU cache to the user space in the non-volatile main memory 120, the checkpoint operation performed in a page unit while the file write operation is performed through a system call, and data logs of the user space. Also, the micro-journaling may further include the I/O vector 612 and the page directory 614, wherein the I/O vector 612 has a pointer to a base address 617 of source data 630 and a length of data 616 for a system call for an unfinished file write caused by the sudden power-off of the system. The consistency and reliability of the file system may be maintained through the recovery process using the micro-journaling.

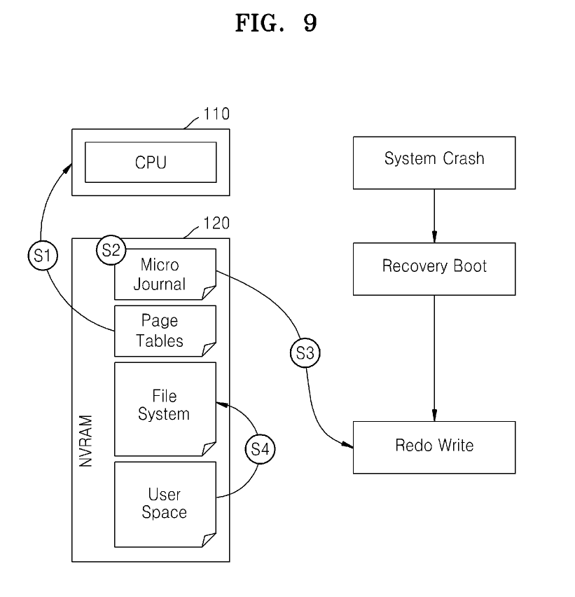

FIG. 10 is a diagram of an MRAM 12 according to an embodiment of the inventive concept.

Referring to FIG. 10, the MRAM 12 is a double data rate device that operates in synchronization with a rising edge/falling edge of a clock signal CK. The MRAM 12 supports various data rates according to an operation frequency of the clock signal CK. For example, when the operation frequency of the clock signal CK is 800 MHz, the MRAM 12 supports a data rate of 1600 MT/s. The MRAM 12 may support data rates of 1600, 1867, 2133, and 2400 MT/s.

The MRAM 12 includes a control logic and command decoder 14 that receives a plurality of command signals and clock signals from an external device, such as a memory controller, via a control bus. The command signals include, for example, a chip select signal CS_n, a write enable signal WE_n, a column address strobe (CAS) signal CAS_N, and a row address strobe signal RAS_n. The clock signals include, for example, a clock enable signal CKE and complementary clock signals CK_t and CK_c. Here, _n denotes an active low signal. t and _c denote a signal pair. The command signals CS_n, WE_n, RAS_n, and CAS_n may be driven by a logic value corresponding to a predetermined command, such as a read command or a write command.

The control logic and command decoder 14 includes a mode registers 15 providing a plurality of operation options of the MRAM 12. The mode registers 15 may program various functions, features, and modes of the MRAM 12. The mode registers 15 may control a burst length, a read burst type, column address strobe (CAS) latency, a test mode, delay-locked loop (DLL) reset, write recovery and read command-to-precharge command features, and DLL use during precharge power down. The mode registers 15 may store data for controlling DLL enable/disable, output drive intensity, additive latency (AL), write leveling enable/disable, termination data strobe (TDQS) enable/disable, and output buffer enable/disable. The mode registers 15 may store data for controlling CAS write latency (CWL), dynamic termination, and write cyclic redundancy check (CRC).

The mode registers 15 may store data for controlling a multi-purpose register (MPR) location function of the MRAM 12, an MPR operation function, a gear down mode, a per MRAM addressing (PDA) mode, and an MPR read format. The mode registers 15 may store data for controlling a power down mode of the MRAM 12, reference voltage (Vref) monitoring, a CS-to-command/address latency mode, a read preamble training (RPT) mode, a read preamble function, and a write preamble function. The mode registers 15 may store data for controlling a command and address (CA) parity function of the MRAM 12, a CRC error state, a CA parity error state, an on-die termination (ODT) input buffer power down function, a data mask (DM) function, a write data bus inversion (DBI) function, and a read DBI function. The mode registers 15 may store data for controlling a VrefDQ training value of the MRAM 12, a VrefDQ training range, VrefDQ training enable, and tCCD timing.

The control logic and command decoder 14 latches and decodes a command applied in response to the complementary clock signals CK_t and CK_c. The control logic and command decoder 14 generates a sequence of the clocking and control signals by using internal blocks for performing a function of an applied command.

The MRAM 12 further includes an address buffer 16 for receiving row, column, and bank addresses A0 through A17, BA0, and BA1, and bank group addresses BG0 and BG1 from the memory controller through an address bus. The address buffer 16 receives a row address, a bank address, and a bank group address applied to a row address multiplexer 17 and a bank control logic 18.

The row address multiplexer 17 applies the row address received from the address buffer 16 to a plurality of address latch and decoders 20. The bank control logic 18 activates the address latch and decoders 20 corresponding to the bank address BA1:BA0 and the bank group signal BG1:BG0 received from the address buffer 16.

The activated address latch and decoders 20 apply various signals to corresponding memory banks 21 so as to activate rows of memory cells corresponding to decoded row addresses. Each of the memory banks 21 includes a memory cell array including a plurality of memory cells. Data stored in the memory cells of the activated rows is detected and amplified by sense amplifiers 22.

A column address is applied to an address bus after row and bank addresses are applied to the address bus. The address buffer 16 applies the column address to a column address counter and latch 19. The column address counter and latch 19 latches the column address, and applies the latched column address to a plurality of column decoders 23. The bank control logic 18 activates the column decoders 23 corresponding to the received bank address and bank group address, and the activated column decoders 23 decode the column address.

According to an operation mode of the MRAM 12, the column address counter and latch 19 directly applies the latched column address to the column decoders 23, or applies a column address sequence starting with a column address provided by the address buffer 16 to the column decoders 23. The column decoders 23 activated in response to the column address from the column address counter and latch 19 apply decode and control signals to I/O gating and DM logic 24. The I/O gating and DM logic 24 accesses memory cells corresponding to the column addresses decoded from the rows of memory cells activated in the accessed memory banks 21.

According to a read command of the MRAM 12, data is read from the addressed memory cells, and is connected to a read latch 25 through the I/O gating and DM logic 24. The I/O gating and DM logic 24 provides N bit data to the read latch 25, and the read latch 25, for example, applies 4 N/4 bits to a multiplexer 26.

The MRAM 12 may have an N pre-fetch architecture corresponding to a burst length N in each memory access. For example, the MRAM 12 may have a 4n pre-fetch architecture retrieving 4 pieces of n bit data. The MRAM 12 may be an x4 memory device that provides and receives 4-bit data per edge. Also, the MRAM 12 may have an 8n pre-fetch. When the MRAM 12 has a 4n pre-fetch and an x4 data width, the I/O gating and DM logic 24 provides 16 bits to the read latch 25 and 4 pieces of 4-bit data to the multiplexer 26.

A data driver 27 sequentially receives N/4-bit data from the multiplexer 26. Also, the data driver 27 receives data strobe signals DQS_t and DQS_c from a strobe signal generator 28, and receives a delayed clock signal CKDEL from a DLL 29. A data strobe (DQS) signal is used by an external device, such as the memory controller, for synchronized reception of read data during a read operation.

In response to the delayed clock signal CKDEL, the data driver 27 sequentially outputs received data to a data terminal DQ according to a corresponding data word. Each data word is output on one data bus by being synchronized to rising and falling edges of the applied clock signals CK_t and CK_c. A first data word is output at a time according to CL programmed after a read command. Also, the data driver 27 outputs the data strobe signals DQS_t and DQS_c having rising and falling edges synchronized to the rising and falling edges of the clock signals CK_t and CK_c.

During a write operation of the MRAM 12, the external device, such as the memory controller, applies, for example, N/4-bit data words to the data terminal DQ, and applies a DQS signal and a corresponding DM signal on a data bus. A data receiver 35 receives each data word and related DM signals, and applies the related DM signals to input registers 36 clocked to the DQS signal.

The input registers 36 latch a first N/4-bit data word and a related DM signal in response to the rising edge of the DQS signal, and latches a second N/4-bit data word and a related DM signal in response to the falling edge of the DQS signal. The input registers 36 provide 4 patched N/4-bit data words and related DM signals to a write first in first out (FIFO) and driver 37 in response to the DQS signal. The write FIFO and driver 37 receives an N-bit data word.

A data word is clocked out in the write FIFO and driver 37, and is applied to the I/O gating and DM logic 24. The I/O gating and DM logic 24 transmits a data word to memory cells addressed in the accessed memory banks 21 upon receiving a DM signal. The DM signal selectively masks predetermined bits or a predetermined bit group from among data words to be written on addressed memory cells.

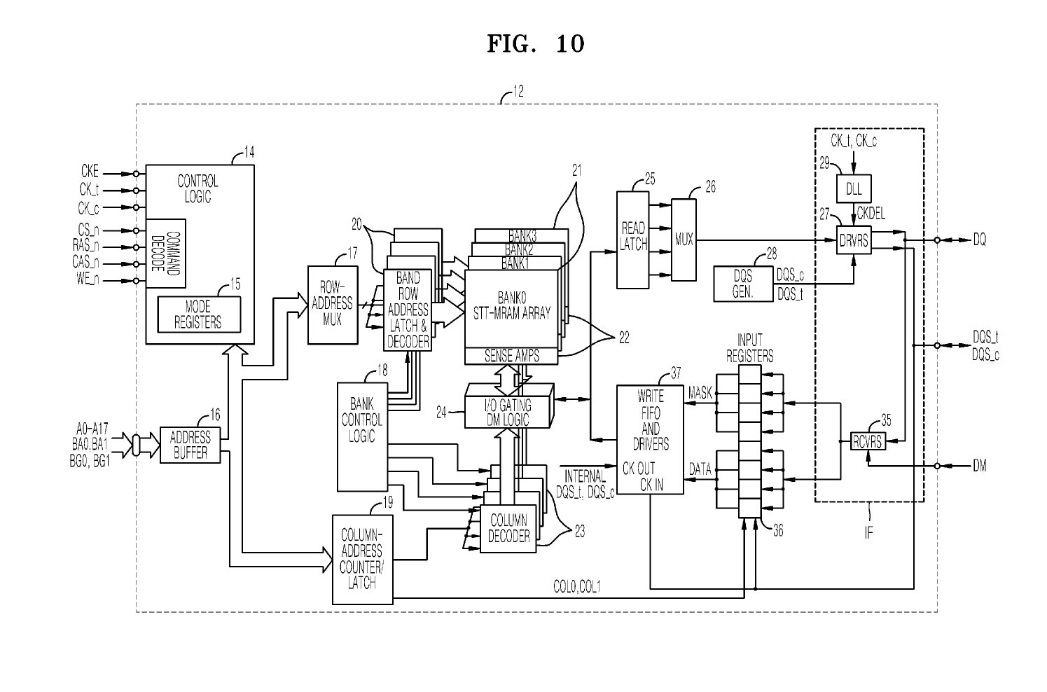

FIG. 11 is a diagram of a memory cell array in the memory bank 21 of FIG. 10, according to one exemplary embodiment.

Referring to FIG. 11, the memory bank 21 includes a plurality of word lines WL0 through WLN, wherein N is a natural number equal to or higher than 1, a plurality of bit lines BL0 through BLM, wherein M is a natural number equal to or higher than 1, a plurality of source lines SL0 through SLn, and a plurality of memory cells 30 disposed at locations where the word lines WL0 through WLN and the bit lines BL0 through BLM cross each other. The memory cell 30 may be realized in an STT-MRAM cell. The memory cell 30 may include an MTJ device 40 having a magnetic material.

The memory cell 30 may include a cell transistor CT and the MTJ device 40. In one memory cell 30, a drain of the cell transistor CT is connected to a pinned layer 41 of the MTJ device 40. A free layer 43 of the MTJ device 40 is connected to the bit line BL0, and a source of the cell transistor CT is connected to the source line SL0. A gate of the cell transistor CT is connected to the word line WL0.

The MTJ device 40 may be replaced by a resistive device, such as a phase change random access memory (PRAM) using a phase change material, a resistive random access memory (RRAM) using a variable resistance material, such as a complex metal oxide, or an MRAM using a magnetic material. Materials forming the resistive devices change a resistance value according to size and/or direction of a current or voltage, and have non-volatile features of maintaining the resistance value even when the current or voltage is blocked.

The word line WL0 is enabled by a row decoder 20 and is connected to a word line driver 32 driving a word line select voltage. The word line select voltage activates the word line WL0 so as to read or write a logic state of the MTJ device 40.

The source line SL0 is connected to a source line circuit 34. The source line circuit 34 receives an address signal and a read/write signal, and generates a source line select signal in the selected source line SL0 based on the received address signal and the read/write signal. A ground reference voltage is provided to the unselected source lines SL1 through SLn.

The bit line BL0 is connected to a column select circuit including the I/O gating and DM logic 24 and driven by column select signals CSL0 through CSLM. The column select signals CSL0 through SCLM are selected by a column decoder 23. For example, the selected column select signal CSL0 turns on a column select transistor in the column select circuit 24 and selects the bit line BL0. A logic state of the MTJ device 40 is read from the bit line BL0 through the sense amplifier 22. Alternatively, a write current applied through the data driver 27 is transmitted to the bit line BL0 and is written on the MTJ device 40.

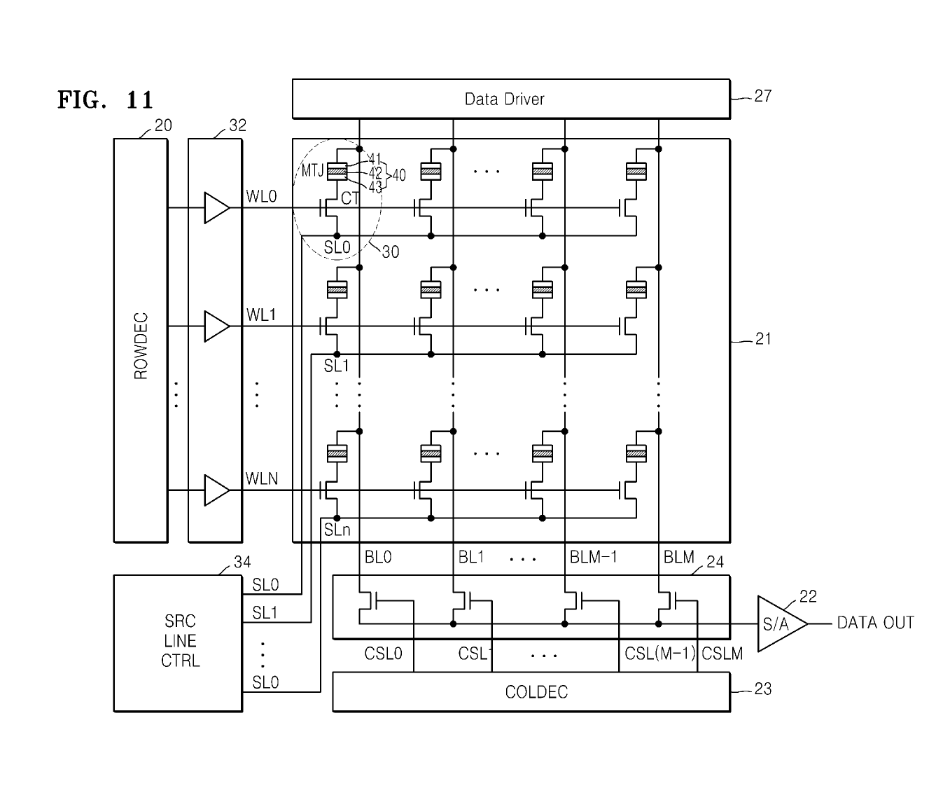

FIG. 12 is a stereogram of an STT-MRAM cell of FIG. 11, according to one exemplary embodiment.

Referring to FIG. 12, the STT-MRAM cell 30 may include the MTJ device 40 and the cell transistor CT. A gate of the cell transistor CT is connected to a word line, for example, the word line WL0, and one terminal of the cell transistor CT is connected to a bit line, for example the bit line BL0, through the MTJ device 40. Another terminal of the cell transistor CT is connected to a source line, for example, the source line SL0.

The MTJ device 40 may include a free layer 41, a pinned layer 43, and a tunnel layer 42 therebetween. A magnetization direction of the pinned layer 43 is fixed, and a magnetization direction of the free layer 41 may be parallel to or anti-parallel to the magnetization direction of the pinned layer 43 according to written data. In order to fix the magnetization direction of the pinned layer 43, for example, an anti-ferromagnetic layer (not shown) may be further included.

In order to perform a write operation of the STT-MRAM cell 30, a logic high voltage is applied to the word line WL0 to turn on the cell transistor CT. A program current, i.e., a write current, provided by a write/read bias generator 45 is applied to the bit line BL0 and the source line SL0. A direction of the write current is determined by a logic state of the MTJ device 40.

In order to perform a read operation of the STT-MRAM cell 30, a logic high voltage is applied to the word line WL0 to turn on the cell transistor CT, and a read current is applied to the bit line BL0 and the source line SL0. Accordingly, a voltage is developed at two ends of the MTJ device 40, sensed by the sense amplifier 22, and compared with a reference voltage from a reference voltage generator 44 to determine a logic state of the MTJ device 40. Accordingly, data stored in the MTJ device 40 may be determined.

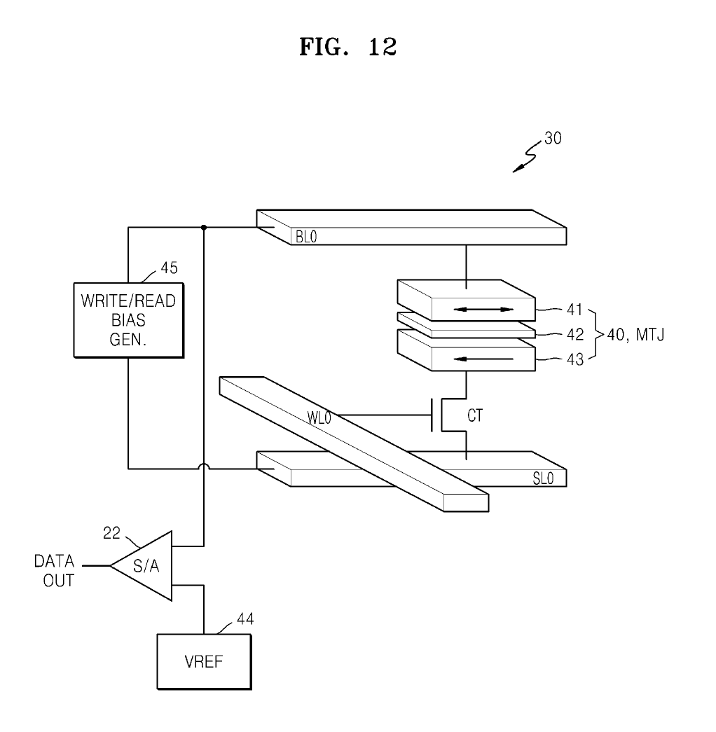

FIGS. 13A and 13B are diagrams for describing a magnetization direction according to data written on the MTJ device 40 of FIG. 12, according to one exemplary embodiment. A resistance value of the MTJ device 40 varies according to the magnetization direction of the free layer 41. When a read current IR flows through the MTJ device 40, a data voltage according to the resistance value of the MTJ device 40 is output. Since the read current IR is much smaller than a write current, the magnetization direction of the free layer 41 is not changed by the read current IR.

Referring to FIG. 13A, the magnetization direction of the free layer 41 and the magnetization direction of the pinned layer 43 are parallel in the MTJ device 40. Accordingly, the MTJ device 40 has a low resistance value. Here, data “0” may be read.

Referring to FIG. 13B, the magnetization direction of the free layer 41 is anti-parallel to the magnetization direction of the pinned layer 43 in the MTJ device 40. Here, the MJT device 40 has a high resistance value. In this case, data “1” may be read.

In the exemplary embodiment of the present inventive concepts, the free and pinned layers 41 and 43 of the MTJ device 40 are shown as horizontal magnetic devices, but alternatively, the free and pinned layers 41 and 43 may be vertical magnetic devices.

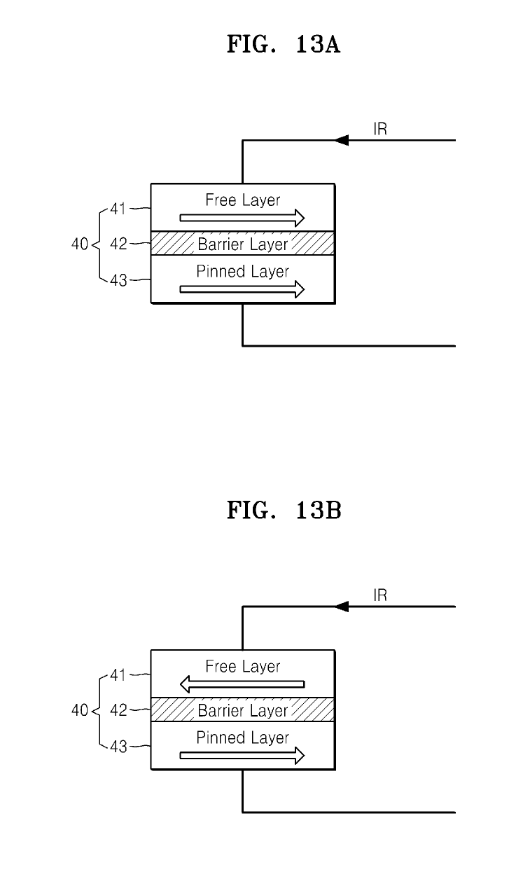

FIG. 14 is a diagram for describing a write operation of the STT-MRAM cell 30 of FIG. 12, according to one exemplary embodiment.

Referring to FIG. 14, the magnetization direction of the free layer 41 may be determined based on a write current IW flowing through the MTJ device 40. For example, when a first write current IWC1 is applied from the free layer 41 to the pinned layer 43, free electrons having the same spin direction as the pinned layer 43 apply a torque on the free layer 41. Accordingly, the free layer 41 is magnetized parallel to the pinned layer 43.

When a second write current IWC2 is applied from the pinned layer 43 to the free layer 41, electrons having a spin opposite to the pinned layer 43 return back to the free layer 41 and apply a torque. Accordingly, the free layer 41 is magnetized anti-parallel to the pinned layer 43. In other words, the magnetization direction of the free layer 41 in the MTJ device 40 may be changed by STT.

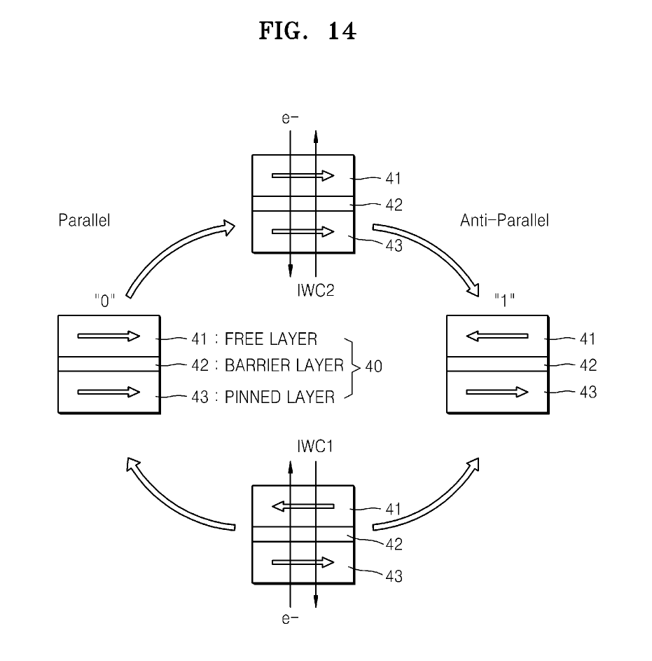

FIGS. 15A and 15B are diagrams for describing MTJ devices 50 and 60 in the STT-MRAM cell 30 of FIG. 12, according to exemplary embodiments of the present inventive concepts.

Referring to FIG. 15A, the MTJ device 50 may include a free layer 51, a tunnel layer 52, a pinned layer 53, and an anti-ferromagnetic layer 54. The free layer 51 may include a material having a variable magnetization direction. The magnetization direction of the free layer 51 may change according to electric/magnetic factors provided outside and/or inside of a memory cell. The free layer 51 may include a ferromagnetic material including at least one of cobalt (Co), iron (Fe), and nickel (Ni). For example, the free layer 51 may include at least one selected from the group consisting of FeB, Fe, Co, Ni, Gd, Dy, CoFe, NiFe, MnAs, MnBi, MnSb, CrO₂, MnOFe₂O₃, FeOFe₂O₃, NiOFe₂O₃, CuOFe₂O₃, MgOFe₂O₃, EuO, and Y₃Fe₅O₁₂.

The tunnel layer 52 may have a thickness that is smaller than a spin diffusion distance. The tunnel layer 52 may include a non-magnetic material. For example, the tunnel layer 52 may include at least one selected from the group consisting of magnesium (Mg), titanium (Ti), aluminum (Al), magnesium-zinc (MgZn), a magnesium-boron (MgB) oxide, a Ti nitride, and a vanadium (V) nitride.

The pinned layer 53 may have a magnetization direction fixed by the anti-ferromagnetic layer 54. Also, the pinned layer 53 may include a ferromagnetic material. For example, the pinned layer 53 may include at least one selected from the group consisting of CoFeB, Fe, Co, Ni, Gd, Dy, CoFe, NiFe, MnAs, MnBi, MnSb, CrO₂, MnOFe₂O₃, FeOFe₂O₃, NiOFe₂O₃, CuOFe₂O₃, MgOFe₂O₃, EuO, and Y₃Fe₅O₁₂.

The anti-ferromagnetic layer 54 may include an anti-ferromagnetic material. For example, the anti-ferromagnetic layer 54 may include at least one selected from the group consisting of PtMn, IrMn, MnO, MnS, MnTe, MnF₂, FeCl₂, FeO, CoCl₂, CoO, NiCl₂, NiO, and Cr.

Since the free layer 51 and the pinned layer 53 of the MTJ device 50 are each formed of a ferromagnetic material, a stray field may be generated at an edge of the ferromagnetic material. The stray field may decrease magnetoresistance or increase resistance magnetism of the free layer 51. Moreover, the stray field affects a switching characteristic, thereby forming asymmetrical switching. Accordingly, a unit for decreasing or controlling a stray field generated by the ferromagnetic material in the MTJ device 50 may be used.

Referring to FIG. 15B, a pinned layer 63 of the MTJ device 60 may be formed of a synthetic anti-ferromagnetic (SAF) material. The pinned layer 63 may include a first ferromagnetic layer 63_1, a barrier layer 63_2, and a second ferromagnetic layer 63_3. The first and second ferromagnetic layers 63_1 and 63_3 may each include at least one selected from the group consisting of CoFeB, Fe, Co, Ni, Gd, Dy, CoFe, NiFe, MnAs, MnBi, MnSb, CrO₂, MnOFe₂O₃, FeOFe₂O₃, NiOFe₂O₃, CuOFe₂O₃, MgOFe₂O₃, EuO, and Y₃Fe₅O₁₂. Here, a magnetization direction of the first ferromagnetic layer 63_1 and a magnetization direction of the second ferromagnetic layer 63_3 are different from each other, and are fixed. The barrier layer 63_2 may include Ru.

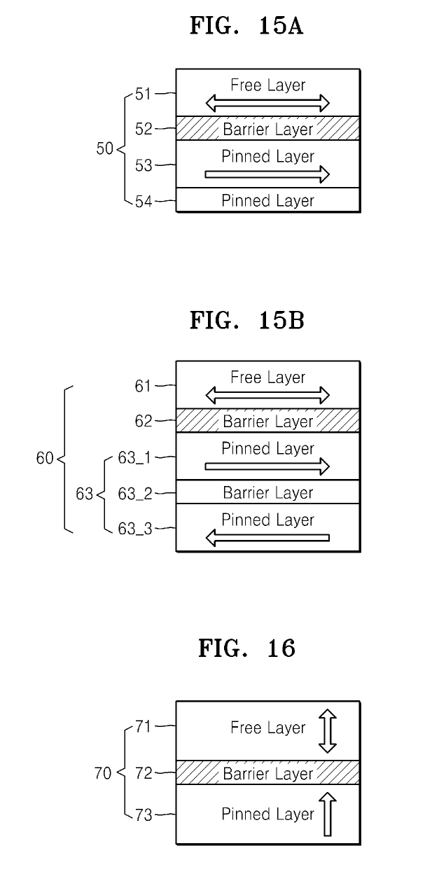

FIG. 16 is a diagram for describing an MTJ device 70 in the STT-MRAM cell 30 of FIG. 12, according to another exemplary embodiment of the present inventive concepts.

Referring to FIG. 16, a magnetization direction of the MTJ device 70 is vertical, and a moving direction of a current and a magnetization easy axis are substantially parallel to each other. The MTJ device 70 includes a free layer 71, a tunnel layer 72, and a pinned layer 73. A resistance value is small when the magnetization directions of the free layer 71 and pinned layer 73 are parallel, and is high when the magnetization directions of the free layer 71 and pinned layer 73 are anti-parallel. Data may be stored in the MTJ device 70 according to such a resistance value.

In order to realize the MTJ device 70 having a vertical magnetization direction, the free layer 71 and the pinned layer 73 may be formed of a material having high magnetic anisotrophy energy. Examples of the material having high magnetic anisotrophy energy include an amorphous rear earth raw material alloy, a thin film such as (Co/Pt)n or (Fe/Pt)n, and a superlattice material having an L10 crystalline structure. For example, the free layer 71 may be an ordered alloy, and may include at least any one of Fe, Co. Ni, palladium (Pa), and platinum (Pt). Alternatively, the free layer 71 may include at least any one of a Fe—Pt alloy, a Fe—Pd alloy, a Co—Pd alloy, a Co—Pt alloy, a Fe—Ni—Pt alloy, a Co—Fe—Pt alloy, and a Co—Ni—Pt alloy. The alloys above may be, for example, Fe₅₀Pt₅₀, Fe₅₀Pd₅₀, Co₅₀Pd₅₀, Co₅₀Pt₅₀, Fe₃₀Ni₂₀Pt₅₀, Co₃₀Fe₂₀Pt₅₀, or Co₃₀Ni₂₀Pt₅₀ in terms of quantitative chemistry.

The pinned layer 73 may be an ordered alloy, and may include at least any one of Fe, Co, Ni, Pa, and Pt. For example, the pinned layer 73 may include at least any one of a Fe—Pt alloy, a Fe—Pd alloy, a Co—Pd alloy, a Co—Pt alloy, a Fe—Ni—Pt alloy, a Co—Fe—Pt alloy, and a Co—Ni—Pt alloy. These alloys may be, for example, Fe₅₀Pt₅₀, Fe₅₀Pd₅₀, Co₅₀Pd₅₀, Co₅₀Pt₅₀, Fe₃₀Ni₂₀Pt₅₀, Co₃₀Fe₂₀Pt₅₀, or Co₃₀Ni₂₀Pt₅₀ in terms of quantitative chemistry.

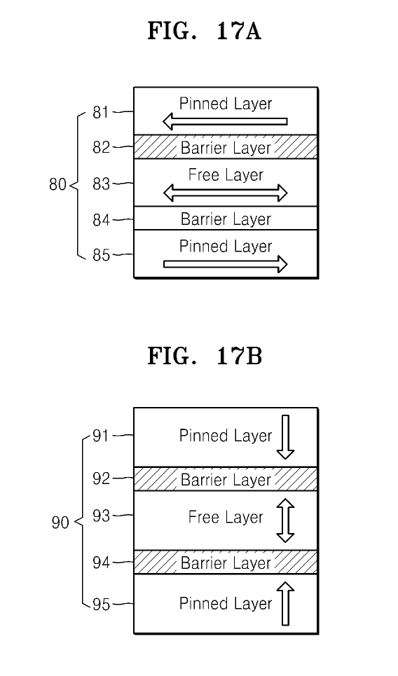

FIGS. 17A and 17B are diagrams for describing dual MTJ devices 80 and 90 in the STT-MRAM cell of FIG. 12, according to other exemplary embodiments of the present inventive concepts. A dual MTJ device has a structure wherein a tunnel layer and a pinned layer are disposed at two ends based on a free layer.

Referring to FIG. 17A, the dual MTJ device 80 forming horizontal magnetism may include a first pinned layer 81, a first tunnel layer 82, a free layer 83, a second tunnel layer 84, and a second pinned layer 85. Materials of the first and second pinned layers 81 and 85 are similar to that of the pinned layer 53 of FIG. 15A, materials of the first and second tunnel layers 82 and 84 are similar to that of the tunnel layer 52 of FIG. 15A, and a material of the free layer 83 is similar to that of the free layer 51 of FIG. 15A.

When magnetization directions of the first and second pinned layers 81 and 85 are fixed to opposite directions, magnetic forces by the first and second pinned layers 81 and 85 substantially counterbalance. Accordingly, the dual MTJ device 80 may perform a write operation by using a smaller current than a general MTJ device.

Since the dual MTJ device 80 provides higher resistance during a read operation by the second tunnel layer 84, an accurate data value may be obtained.

Referring to FIG. 17B, the dual MTJ device 90 forming vertical magnetism includes a first pinned layer 91, a first tunnel layer 92, a free layer 93, a second tunnel layer 94, and a second pinned layer 95. Materials of the first and second pinned layers 91 and 95 are similar to that of the pinned layer 73 of FIG. 16, materials of the first and second tunnel layers 92 and 94 are similar to that of the tunnel layer 72 of FIG. 16 and a material of the free layer 93 is similar to that of the free layer 71 of FIG. 16.

Here, when magnetization directions of the first and second pinned layers 91 and 95 are fixed in opposite directions, magnetic forces by the first and second pinned layers 91 and 95 substantially counterbalance. Accordingly, the dual MTJ device 90 may perform a write operation by using a smaller current than a general MTJ device.

The STT-MRAM may be used as a main memory of a system. Since the STT-MRAM is byte-addressable and is capable of permanently storing data, a double duplication process of data performed to increase reliability of a file system may be omitted. Also, since the STT-MRAM is used in the micro-journaling for recording logging information and checking a point during file writes, the file system may be recovered when the system is suddenly turned off.

While the inventive concept has been particularly shown and described with reference to exemplary embodiments thereof, it will be understood that various changes in form and details may be made therein without departing from the spirit and scope of the following claims.

What is claimed is:

1. A system comprising:
a microprocessor having a dirty cache line;
a non-volatile main memory configured to store update data by flushing the dirty cache line during a commit operation; and
a storage device having a swap space configured to swap pages with the non-volatile main memory.

2. The system according to claim 1, wherein the non-volatile memory has a user space storing the update data and a kernel space having a micro-journal.

3. The system according to claim 2, wherein the system is configured to move the update data is to the kernel space during a checkpoint operation.

4. The system according to claim 3, wherein the non-volatile main memory includes a micro-journal having a page directory pointer and a checkpoint information.

5. The system according to claim 4, wherein the micro journal further includes a base virtual address and a data length.

6. The system according to claim 5, wherein the non-volatile main memory includes a page directory and page table to convert the base virtual address to a physical address pointing the update data.

7. The system according to claim 6, wherein the base virtual address includes a first address portion to point to an entry of the page directory and a second address portion having an offset of the page table.

8. The system of claim 1, wherein the non-volatile main memory is any one of a spin transfer torque magnetic random access memory (STT-MRAM), a resistance random access memory (ReRAM), and an MRAM, and a ferroelectric random access memory (FeRAM).

9. The system of claim 1, wherein the storage device is a flash memory device storing a flash translation layer.

10. The system of claim 5, wherein the microprocessor is configured to flush all the dirty cache lines that belong to an address region of the data length from the base virtual address.

11. A method of performing a transactional write in a file system, the method comprising :
receiving a write system call from the file system;
flushing a dirty cache line of a microprocessor;
updating data in a non-volatile main memory from the dirty cache line of the microprocessor during a commit operation by the write system call; and
creating a micro journal having a virtual address in the non-volatile main memory for pointing to the updated data.

12. The method of claim 11, wherein the updated data is stored in a user space in the non-volatile main memory.

13. The method of claim 12, wherein the micro journal is stored in a kernel space of the non-volatile main memory.

14. The method of claim 13, further comprising moving the updated data from the user space to the kernel space during a checkpoint operation.

15. The method of claim 14, further comprising invaliding the micro journal after finishing the checkpoint operation.

16. The method of claim 15, further comprising swapping pages in the kernel space by using a swapping space in a storage device when there is not enough space in the kernel space to store the updated data.

17. The method of claim 15, further comprising executing an instruction barrier instruction and a cache flush instruction before flushing the dirty cache line.

18. A method of booting a system having a non-volatile main memory connected between a microprocessor and a storage device, the method comprising:
checking a state of a file system stored in the system;
accessing a page table of the file system;
accessing a micro journal generated by a commit operation by a write system call in a kernel space of the non-volatile main memory;
accessing user data in a user space of the non-volatile main memory according to the micro-journal; and
moving the user data from the user space to the kernel space by a checkpoint operation.

19. The method of claim 18, further comprising marking a checkpoint information field in the micro-journal during the checkpoint operation.

20. The method of claim 18, wherein the accessing of the page table and the accessing of the micro-journal comprise:
searching the page table in the kernel space;
accessing a page directory and an input/output (I/O) vector of the micro-journal; and
converting a virtual address to a physical address to point the user data in the user space.
